(19) United States
(12) Patent Application Publication
(10) Pub. No.: US 2009/0079393 A1
(43) Pub. Date: Mar. 26, 2009

(54) Self-Charging Generator

(76) Inventor: Ozkan Ali Teca, Paterson, NJ (US)

Correspondence Address: OZKAN TECA, 382 KNICKERBOCKER AVE., PATERSON, NJ, 07503, US

(21) Appl. No.: 11/697,396

(22) Filed: Sep. 20, 2007

(51) Int. Cl. H02J 7/00; H02N 11/00

(52) U.S. Cl. 320/128; 74/DIG. 9

(57) ABSTRACT

A portable self charging external power source that can be used by construction workers to help in the supply of electricity for their tools on a site where electricity may not be accessible. It can also be used by anyone needing a portable self charging 110 volt alternating current power source. My invention does not have any harmful exhaust fumes or moving parts which can be dangerous to humans or animals.

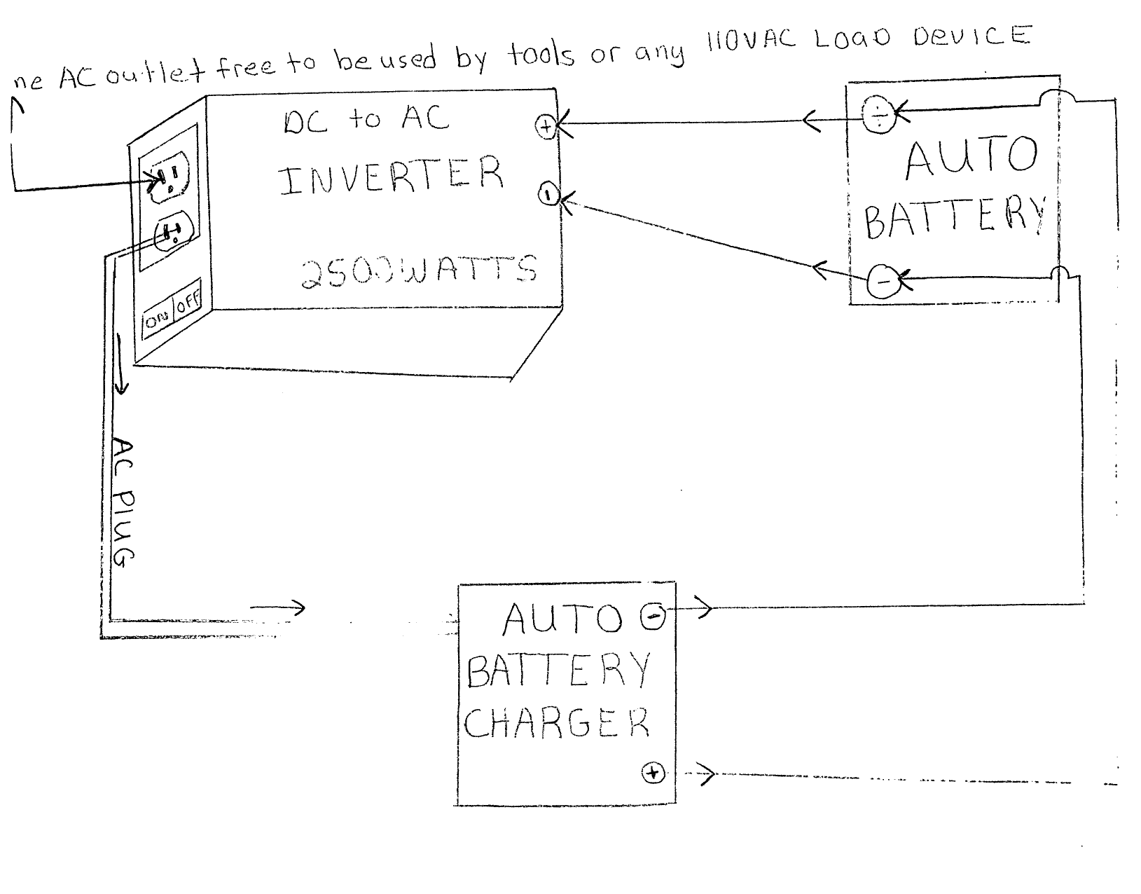

Background Field of Invention: An all-electronic self-charging portable generator used to supply 110 Volt AC power for tools and/or machinery.

Background of the Invention: Electricity is a highly used energy source in our everyday lives. Every home and business have more than 10 items that use electricity all day every day. There are many businesses, people, and government agencies that use generators to supply electricity to electronic items. These generators are powered by gasoline and oil which cause fumes which are harmful to our air. These generators are also limited in their place of use because of being attached to a fixed building or fixture that houses electricity.

Summary: To provide a portable 110 volt AC power source to tools, machinery and/or any AC powered load device without the need of burning any type of fuel for the energy as in gasoline powered generators.

Description of Invention: My invention is an all-electronic device that generates electricity by constantly recharging itself without the use of fuels to be burned or oils to lubricate moving parts.

Operation of Invention: An automotive battery is used to power a 2500 watt DC (Direct Current) to AC (Alternating Current) Inverter. An Inverter then turns the DC power from the Automotive battery into a 110 volt AC power source. The inverter has two 110 volt AC outlets on the side of it. The automotive battery charger plugs into one of the 110 volt AC outlets on the side of the inverter. It then sends a direct current power to the battery keeping the battery fully charged while it sending direct current power to the inverter. While the battery is powering the inverter the inverter is powering the charger and the charger is recharging the battery keeping the whole system going. There is one 110 volt AC outlet on the side of the inverter that can be used to power any tools, machinery and/or any 110 volt AC load device.

The inverter, battery charger and battery are all strapped down to a 2 foot by 3 foot piece of plywood with handles to ease in the transportation of the self-charging generator. My invention will power ay 110 volt AC powered device without adding any oil or fuel to generate the power. My invention will continue powering any device while it is recharging itself until the invention is turned off.

Advantages: Usually when electronic items are used there needs to be a source of electricity that is either housed by a gas powered generator or an extension cord attached to a building. Then one must make sure that they have plenty of gasoline around and it is safe or can not travel to far from a building. Also with the gasoline there are fumes which harm the earth's atmosphere. My invention does not cause any exhaust fumes which can be harmful to people around. My invention is an all encompassed generator that does not need constant fueling to keep it going. This would enable a generator to be used in places where it was not possible or feasible before. My invention is portable so its accessibility is greater.

My invention generated several times the power it consumes to operate and does so by an all electric means with no moving parts.

1. Self-Charging Generator, comprising:
a. Inverter 2500 WAC
b. Automotive Battery Charger
c. Automotive Battery 12 volt
